(19) United States
(12) Patent Application Publication
(10) Pub. No.: US 2007/0043958 A1
(43) Pub. Date: Feb. 22, 2007

(54) Method of managing recording medium, library apparatus and information processing apparatus

(75) Inventor: Shinobu Sasaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/289,026

(22) Filed: Nov. 29, 2005

(30) Foreign Application Priority Data
Aug. 19, 2005 (JP) 2005-238983

(51) Int. Cl. G06F 12/14

(52) U.S. Cl. 713/194

(57) ABSTRACT

The recording media recording an encrypted data or non-encrypted data therein, wherein the management of the recording media is reinforced by protecting the recording media (cartridge 8) from taking out without authorization etc. Recognition information is generated to identify that the recorded data in the recording media is an encrypted data or non-encrypted data, and record the recognition information in the recognition tag. The recording media has the recognition section 10 having the recognition information to identify whether the recorded data is an encrypted data or non-encrypted data.

### CROSS-REFERENCE TO RELATED APPLICATIONS

This application is based upon and claims the benefit of priority from the prior Japanese Patent Application No. 2005-238983, filed on Aug. 19, 2005, the entire contents of which are incorporated herein by reference.

### BACKGROUND OF THE INVENTION

1. Field of the Invention

The present invention relates to a security management of recording medium such as magnetic tape etc. stored in a cartridge, more particularly, to management method of the recording medium to prevent from taking out the recording medium without authorization or writing into a data recorded in the recording medium without authorization, a recording medium, library apparatus and information processing apparatus.

2. Description of the Related Art

Conventionally, a center system provides a high security system for a large-scale information processing system using a main frame such as restriction of people go in and out, there is limited necessity to provide security measures for the library apparatus storing recording medium separately from the center system.

However, as a large-scale information processing system develops as an open system to realize a distributed center system, a high security measures separately from the center system is requested, it is therefore urgently requested to provide a security measures for the recording medium stored in the library apparatus.

Referring to managing the recording media, Japanese Patent Application Laid-open Publication No. 2003-77255, Para. 0015, FIG. 1 etc. discloses a magnetic tape cartridge having a memory for storing version information such as memory size of the magnetic tape cartridge, and reading means provided on the holder means of the cartridge to read memorized contents of the memory, and Japanese Patent Application Laid-open Publication No. 2002-117644, Para. 0019, FIG. 1 etc. discloses a tape cartridge having an IC chip for data recording.

Referring to Japanese Patent Application Laid-open Publication No. 2003-77255 simply discloses reading of version information such as memory size etc. from the noncontact type memory attached to the tape cartridge. Japanese Patent Application Laid-open Publication No. 2002-117644 discloses the IC chip attached to the tape cartridge, wherein the IC chip simply records a management data such as a directory, use history data etc. and maker information such as a lot number, tape specification and characteristic data etc.

Information goes out if a data in the recording medium recording non-encrypted data is taken out without authorization. It is a critical problem to prevent from taking out the recording media without authorization for security measures. In addition, even if the recording medium is prevented from taking out without authorization, data on the recording medium cannot be protected without protection from recording into the recording medium without authorization.

Both Japanese Patent Application Laid-open Publication No. 2003-77255 and Japanese Patent Application Laid-open Publication No. 2002-117644 neither teach nor suggest security measures of the recording medium, nor structure to solve such problem.

### SUMMARY OF THE INVENTION

First object of the present invention relates to the management of the recording medium for reinforcing management function of the recording medium such as prevention from taking out the recording medium without authorization etc.

Second object of the present invention relates to the management of the recording medium for reinforcing the protection function of the recorded data in the recording medium.

In order to achieve the above object, according to a first aspect of the present invention there is provided a method of managing a recording medium recording an encrypted data or a non-encrypted data therein, comprising the steps of generating recognition information recognizing whether a data recorded in the recording medium is an encrypted data or a non-encrypted data; and writing said recognition information into a recognition section attached to said recording medium.

According to the above structure, encryption of the recorded data is a processing for the security of the data. By encrypting the recorded data in the recording medium, security of the recorded data and the recording medium are protected from taking out without authorization. However, whether the recorded data is encrypted or not cannot be recognized from external appearance of recording medium, for example, separately from the recorded data. Therefore, by writing recognition information indicating whether the recorded data is encrypted or not into a recognition section attached to the recording medium, whether the recorded data is encrypted or not can be easily recognized based on the recognition information of the recognition section. Accordingly, a recognition section is provided on the recording medium for managing the recording medium and by writing the above described recognition information in the recognition section for using as management information, management function such as prevention from taking out the recording medium without authorization can be reinforced.

In order to achieve the above object, according to a second aspect of the present invention there is provided a library apparatus storing a recording medium, the recording medium comprising a recognition section in which recognition information recognizing whether a recorded data is an encrypted data or a non-encrypted data is written.

According to the above structure, as described above, encryption of the recorded data is for security thereof. By attaching the recognition section to the recording medium, and by writing the recognition information indicating whether the recorded data is an encrypted data or not to the recognition section, whether the recorded data is encrypted or not can be known based on the recognition information read from the recognition section, separately from the recorded data in the recording medium. Therefore, according to the library apparatus of the present invention, whether the recorded data in the recording medium is encrypted or not can be recognized from the recognition information of the recognition section without reading the data recorded in the recording medium. In other words, security of the recorded data and the recording medium having the recorded data can be improved because of handling depending on whether the recorded data is encrypted or not.

The library apparatus may further comprise a recognition information writing section writing said recognition information into said recognition section. The library apparatus may further comprise a recognition information reading section reading said recognition information from said recognition section. The library apparatus may further comprise a detection section detecting removal of said recording medium from a storage area; and a notification section generating notification output indicating the removal of said recording medium from said storage area based on output detected by said detection section. The library apparatus may further comprise an entry section entering identification information; and a processing section deciding whether said identification information coincides with identification information preliminary registered, and prohibiting ejection of said recording medium or data processing in case that said identification information does not coincide with the identification information preliminary registered. The library apparatus may further comprise an entry section entering identification information; and a processing section encrypting said recorded data by using encryption information generated based on said identification information, and recording the encrypted data in said recording medium. The library apparatus may further comprise an encryption information generation section generating encryption information based on identification information. In the library apparatus, said identification information is biometric information.

In order to achieve the above object, according to a third aspect of the present invention there is provided an information processing apparatus having a library apparatus storing a recording medium, the recording medium comprising a recognition section in which recognition information recognizing whether a recorded data is an encrypted data or a non-encrypted data is written.

The information processing apparatus may further comprise a recognition information writing section writing said recognition information into said recognition section. The information processing apparatus may further comprise a recognition information reading section reading said recognition information from said recognition section. The information processing apparatus may further comprise a detection section detecting removal of said recording medium from a storage area; and an notification section generating notification output indicating the removal of said recording medium from said storage area based on output detected by said detection section. The information processing apparatus may further comprise entry section entering identification information; and a processing section deciding whether said identification information coincides with identification information preliminary registered, and prohibiting ejection of said recording medium or data processing in case that said identification information does not coincide with the identification information preliminary registered. The information processing apparatus may further comprise an entry section entering identification information; and a processing section encrypting said recorded data by using encryption information generated based on said identification information, and recording the encrypted data in said recording medium. The information processing apparatus may further comprise an encryption information generation section generating encryption information based on identification information. In the information processing apparatus, said identification information may be biometric information.

In order to achieve the above object, there may be provided a method of managing a recording medium recording an encrypted data or a non-encrypted data therein, comprising the step of reading recognition information recognizing whether a data recorded in the recording medium is an encrypted data or a non-encrypted data, from a recognition section in which said recognition information is written. The method of managing a recording medium may further comprise the steps of detecting removal of said recording medium from a storage area of said recording medium by reading said recognition information, wherein said recording medium at least has a non-encrypted data as a recorded data; and instructing the removal upon removal of said recording medium from said storage area. The method of managing a recording medium may further comprise the steps of verifying identification information before ejecting said recording medium from said storage area; and prohibiting ejection of said recording medium if said identification information does not coincide with identification information preliminary registered.

In order to achieve the above object, there may be provided a method of managing a recording medium, comprising the steps of requesting an entry of identification information upon recording a data into the recording medium; generating encryption information based on said identification information; encrypting said data to be recorded, by using said encryption information; and recording the encrypted data in said recording medium.

According to the above structure, security of the data recorded in the recording medium can be reinforced by using encryption information based on the identification information for encrypting the data to be recorded in the recording medium.

In order to achieve the above object, there may be provided a method of managing a recording medium, comprising the steps of: requesting an entry of identification information upon reading a data recorded in the recording medium; generating encryption information based on said identification information; and decoding said recorded data by using said encryption information.

In order to achieve the above object, there may be provided a recording medium recording an encrypted data or a non-encrypted data therein, comprising a recognition section in which recognition information recognizing whether a recorded data is an encrypted data or a non-encrypted data is written.

According to the above structure, the recording medium includes a magnetic tape, discs and so on for recording data, and such recording medium is stored in a cartridge. The encryption of data recorded in the recording medium is for improving security as described above, thus security of the recorded data and the recording medium against taking out without authorization etc. can be provided by encrypting data recorded in the recording medium. However, whether the recorded data is encrypted or not cannot be recognized from external appearance of recording medium. By attaching a recognition section to the recording medium, and by writing the recognition information indicating whether the recorded data in the recording medium is encrypted data or not to the recognition section, whether the recorded data is encrypted or not can be recognized based on the recognition information, separately from the recorded data in the recording medium.

In the recording medium, said recognition section may be an IC tag recording said recognition information.

The features and advantages of the present invention can be enumerated as follows:

(1) Security function of the recording medium and the recorded data therein can be improved by writing recognition information indicating whether the recorded data is an encrypted data or not in the recognition section attached to the recording medium for managing the recording medium and the recorded data therein.

(2) Security function of the recording medium and the recorded data therein can be improved by recognizing whether the recorded data in the recording medium is an encrypted data or not based on recognition information of the recognition section attached on the recording medium.

(3) According to the library apparatus using such recording medium, security function of the library apparatus can be enhanced.

(4) Security function for information processing can be improved by using such library apparatus and recording medium for the information processing apparatus.

Other objects, features and advantages of the present invention can be further clarified by referring to the attached drawings and embodiments of the present invention.

### BRIEF DESCRIPTION OF THE DRAWINGS

FIG. 1 is a block diagram showing an information processing apparatus according to a first embodiment of the present invention.

FIG. 2 is a schematic perspective view showing a cartridge having an IC tag.

FIG. 3 is a block diagram showing a structure of an IC tag.

FIG. 4 is a schematic side-view showing a main body of a robot section having an IC tag reader/writer.

FIG. 5 is a block diagram showing a structure of an IC tag reader/writer.

FIG. 6 is a block diagram showing a structure of IC tag reader.

FIG. 7 is a block diagram showing a structure of a library control section.

FIG. 8 is a schematic view showing an operator panel.

FIG. 9 is a perspective view showing a structure of a library apparatus.

FIG. 10 is a block diagram showing operational sequence.

FIG. 11 is a flow chart showing process of encryption key generation.

FIG. 12 is a flow chart showing process of writing data into a cartridge and writing recognition information into an IC tag.

FIG. 13 is a flow chart showing process of reading and decoding data in a cartridge.

FIG. 14 is a flow chart showing process of reading an encryption key.

FIG. 15 is a flow chart showing process of monitoring taking out a cartridge.

FIG. 16 is a flow chart showing process of cartridge ejection and biometric identification.

FIG. 17 is a flow chart showing process of cartridge ejection including password identification.

FIG. 18 is a flow chart showing process of cartridge ejection including recording ejection history.

FIG. 19 is a block diagram showing a library control section according to a second embodiment of the present invention.

FIG. 20 is a flow chart showing process of cartridge ejection including password identification process and biometric identification process

FIG. 21 is a schematic perspective view showing other structure example of a recognition section of a cartridge.

FIG. 22 is a schematic perspective view showing other structure example of a recognition section of a cartridge.

FIG. 23 is a perspective view showing other structure example of a library apparatus.

### DETAILED DESCRIPTION OF THE PREFERRED EMBODIMENTS

### First Embodiment

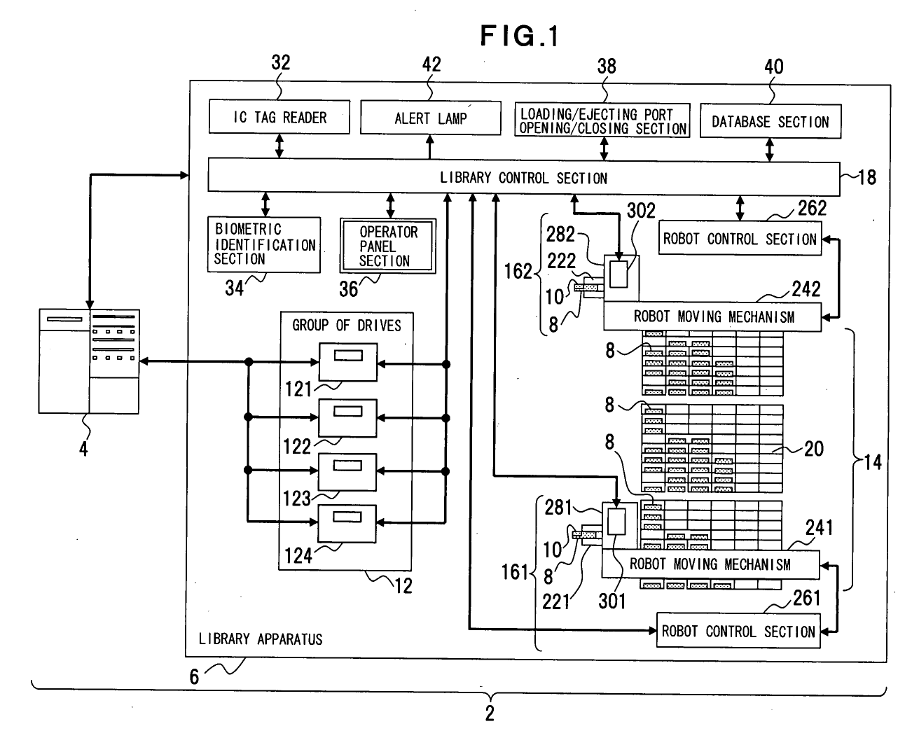

Referring to FIG. 1, described are a method of managing recording medium, recording medium, library apparatus and an information processing apparatus according to a first embodiment of the present invention. FIG. 1 is a block diagram showing the information processing apparatus having the library apparatus.

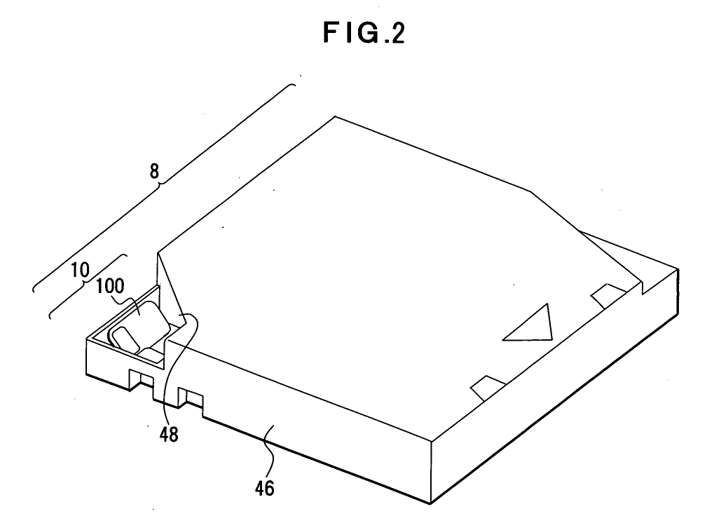

The information processing apparatus 2 makes a host computer 4 cooperate a library apparatus 6 and performs various information processing by using recording medium stored in the library apparatus 6. The host computer 4 has a processor and memory necessary for the information processing. For example, a cartridge type magnetic tape 8, (hereafter cartridge) is used as a recording medium recording various data including non-encrypted data or encrypted data. The cartridge 8 has a recognition section 10 (Refer to FIG. 2) This recognition section 10 records and shows recognition information about the recorded data in the cartridge 8. Here, the recognition information indicates if the recorded data in the cartridge 8 is an encrypted data or not (in other words, non-encrypted data or encrypted data) and is comprised of an electronic data recorded in the recording medium or a visible data such as a symbol. Here, the recognition information written or displayed in the recognition section 10 can be directly read or recognized from recognition section 10, separately from reading the cartridge 8. In this embodiment, this recognition section 10 is comprised of, for example, an IC tag 100 as a recording medium being able to read/write the recognition information.

The library apparatus 6 has a group of drives 12 as an example of reading/writing devices, a cartridge storage section 14,and robot sections 161, 162 as an example of a cartridge transport mechanism. The library apparatus 6 has a library control section 18 as a processing section for performing identification, encryption generation etc and a control section for controlling various functional sections. The group of drives 12 is an example of a single or a plurality of reading/writing device for reading/writing information from/to the cartridge 8. According to this embodiment, a plurality of drives 121, 122, 123, 124 configures the group. The cartridge 8 is stored in a cartridge storage section 14. The cartridge storage section 14 has a plurality of cells 20 to store each of cartridges 8 therein. The cells 20 are arranged in a plurality of rows and a plurality of columns so that the location is to be specified, and each cell 20 stores the cartridge 8. A storage location (position information) of the cartridge 8 is specified by the cell 20. In this case, the library apparatus 6 provides a storage area of the cartridges 8 for storing the cartridges 8 therein.

The robot sections 161, 162 transport the cartridge 8 from the cartridge storage section 14 to the group of drives 12, or from the group of drives 12 to the cartridge storage section 14. In this embodiment, two robot sections 161, 162 are provided, however, either one of robot section 161 or 162 may be used to configure the apparatus. If the two robot sections 161, 162 are provided, span of transport of the cartridges 8 against the cells 20 of the cartridge storage section 14 can be divided by each of robot sections 161, 162, or the robot sections 161, 162 may be optionally selected to transport the cartridge 8 within the same span of transport.

The robot section 161 has a picker section 221 to clutch the cartridge 8, a robot moving mechanism 241 to move the picker section 221 to a specified location and a robot control section 261., and also, the robot section 162 has a picker section 222 to clutch the cartridge 8, a robot moving mechanism 242 to move the picker section to a specified location and a robot control section 262. The movement control of the cartridge 8 by the robot sections 161, 162 is executed, based on reading/writing instructions from the host computer 4 for execution, by the library control section 18. The library control section 18 applies a control instructions to the robot control sections 261, 262. The corresponding robot moving mechanism 241, 242 move main body sections 281, 282 supporting the picker sections 221, 222 in X-axis, Y-axis or Z-axis direction, and rotate the picker sections 221, 222 at S-axis of the center. By using such mechanism, the cartridge 8 is moved to a specified drive 121, 122, 123, 124 in the group of drives 12, or from the drive 121, 122, 123, 124 to a specified cell 20.

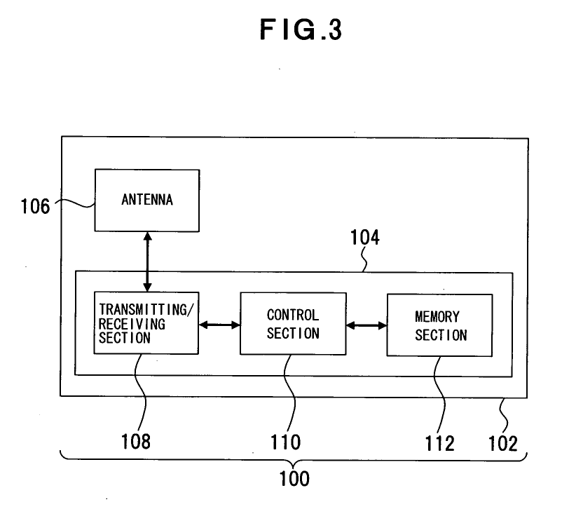

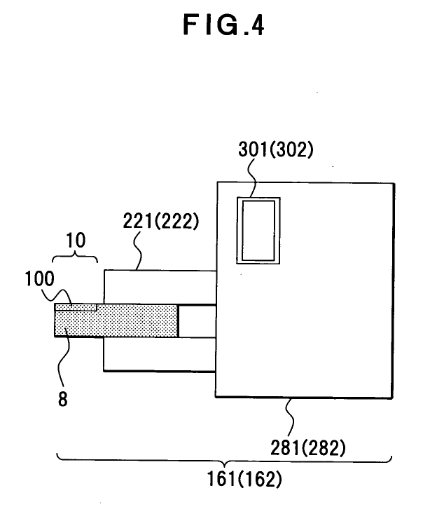

The main body sections 281, 282 of each robot sections 161, 162 have IC tag reader/writer 301, 302 as a recognition information writing/reading section to be used for writing/reading the recognition information to/from the IC tag 100 (Refer to FIG. 3) of cartridge 8 (Refer to FIG. 4). The IC tag reader/writer 301 reads/writes the IC tag 100 of the cartridge 8 held by the picker section 221 as the subject for reading and writing the information, and the IC tag reader/writer 302 reads/writes the IC tag 100 of the cartridge 8 held by the picker section 222 as the subject for reading and writing the information. The library control section 18 executes control of reading/writing information from/to the IC tag reader/writer 301, 302.

Then, the library control section 18 executes processing such as managing security of the cartridge 8, recording data, generating encryption key, encrypting the recorded data, identifying an operator, controlling writing/reading recognition information to/from the IC tag 100, managing history such as taking out the cartridge 8 etc., managing loading/ejecting cartridge 8, notifying alert etc., processing accompanying these processing, and other information processing. The library control section 18 is connected with the above described group of drives 12, the robot control sections 261, 262, IC tag reader/writer 301, 302, IC tag reader 32, a biometric identification section 34, the operator panel section 36, a loading/ejecting port opening/closing section 38, a database section 40, and an alert lamp 42.

As to the library control section 18, in the identification processing, it is determined whether the operator is acceptable or not. The operator is distinguished by comparing preliminary, registered information with biometric information as an example of identification information entered from the biometric identification section 34 by the operator. In this case, an operator's face image can be used as biometric information. If an operator is not a non-registered person, ejection of the cartridge 8 from the loading/ejecting port opening/closing section 38 is prohibited, and notification output indicating anomaly is generated to light the alert lamp 42.

In the generation processing of encryption information based on the identification information in the library control section 18, for example, used is identification information obtained from an operator by the biometric identification section 34. In this case, an encryption key is generated by using biometric information as one of the identification information. This encryption key is used for encrypting the recorded data in the cartridge 8. The encryption key is also used for restoring the recorded data from the cartridge 8 as a decoding information.

The IC tag reader 32 is an example of the information reading section for reading the IC tag 100, which is installed at an opening of the library apparatus 6 for reading the above described recognition information from the IC tag 100 attached to the cartridge 8 to be taken out from the library apparatus 6. As described above, the recognition information identifies whether the recorded data in the cartridge 8 is encrypted data or not encrypted data. The recognition information read by the IC tag reader 32 is taken in the library control section 18 for using to prevent from taking out the cartridge 8 without authorization, more specifically, to prevent from taking out the cartridge 8 recording a non-encrypted data without authorization. If it is detected that the cartridge 8 having a non-encrypted data is taking out without authorization, ejection of the cartridge 8 from the loading/ejecting port opening/closing section 38 is blocked, notification output indicating anomaly is outputted, and the alert lamp 42 is lit to alert.

The biometric identification section 34 obtains biometric information for identification and informs the library control section 18 of the biometric information as identification information. In other words, the biometric identification section 34 takes in biometrics information about an operator of the cartridge 8, such as venous information or image information.

The operator panel section 36 has an information display section and a keyboard etc. to have the operator enter identification information such as a password etc. and other information. In this case, characters or symbols configure the password as identification information.

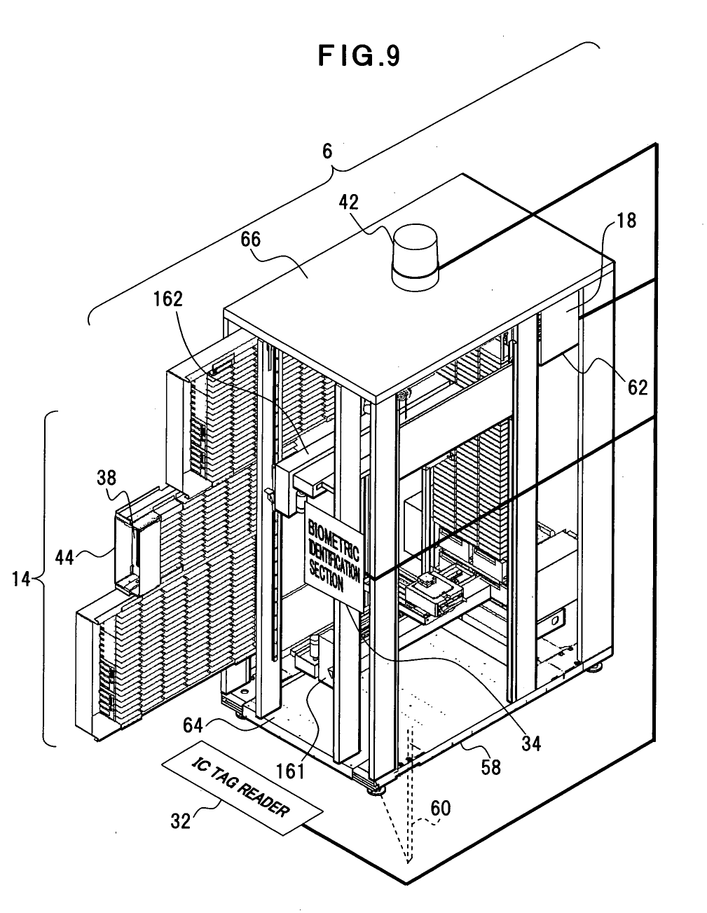

The loading/ejecting port opening/closing section 38 is a mechanism for opening or closing a door etc. at a cartridge loading/ejecting port 44 (Refer to FIG. 9) of the library apparatus 6, which is controlled by the library control section 18. According to this control, as described above, the ejection of the cartridge 8 is blocked if an illegal state is found, the ejection of the cartridge 8 is allowed if in the case of a normal case.

The database section 40 records history information. The history information includes presence of taking out of the cartridge 8, person who takes out, time/date of taking out, etc. Such information are based on information read out by the IC tag reader 32 and identification information of the biometric identification section 34 in addition to input information from the operator panel section 36.

The alert lamp 42 is an example of notification section indicating anomaly information etc., for example, a patrol-light may be used. The alert lamp 42 is lit or blinked by an output from the library control section 18, namely by notification output indicating anomaly. Anomaly notification may be notified by images and characters on display part of the operator panel section 36, or by sound information by providing a sound output section.

Next, the structure of the recognition section 10 on the cartridge 8 is described referring to FIG. 2 and FIG. 3. FIG. 2 is a schematic view showing the cartridge having the IC tag. FIG. 3 is a block diagram showing a structure of the IC tag. The same reference numerals in FIG. 1 are used for the same constituents in FIG. 2 and FIG. 3.

As FIG. 2 shows, the cartridge 8 has a case 46 for storing a medium such as magnetic tape etc. to record information. The case 46 is made of a synthetic resin etc. The above described recognition section 10 provided is provided on a part of this case 46. In this embodiment, the IC tag 100 is used for the recognition section 10, which is attached on an optional location of the case 46, in this figure, a concaved portion 48 at a corner. In this embodiment, the concaved portion 48 is left open so that the IC tag 100 is installed therein with exposing its surface. This IC tag 100 can be integrally structured within the case 46 or with the surface area thereof.

As FIG. 3 shows, the IC tag 100 has an antenna 106 in a coil shape together with an IC chip 104 on a substrate 102. The IC chip 104 has a transmitting/receiving section 108, control section 110, and a memory section 112. The transmitting/receiving section 108 transmits/receives radio signals of a specified frequency through the antenna 106 while wireless information is prepared in a high frequency signal by modulating a data signal read out from the memory section 112. As a result, wireless information in an electromagnetic wave of a specified frequency can be transmitted and received through the antenna 106. The control section 110 performs control of transmitting/receiving of the_transmitting/receiving section 108, and records/reads various information to/from the memory section 112. The above described recognition information as described above, and program etc. are recorded in the memory section 112. In this case, the recognition information is recorded into the memory section 112 by using the IC tag reader/writer 301, 302.

According to this structure, the recognition information indicating whether the recorded data in the cartridge 8 is an encrypted data or non-encrypted data, is recorded in the IC tag 100 attached separately to each of the cartridge 8. By reading the recorded information, the type of the recorded data in the cartridge 8 can be easily known from the IC tag 100 without reading/developing the recorded data.

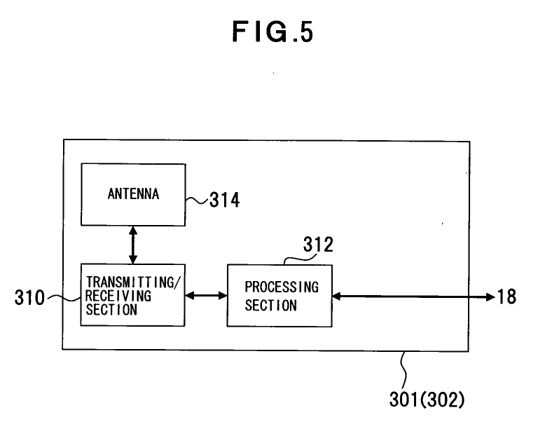

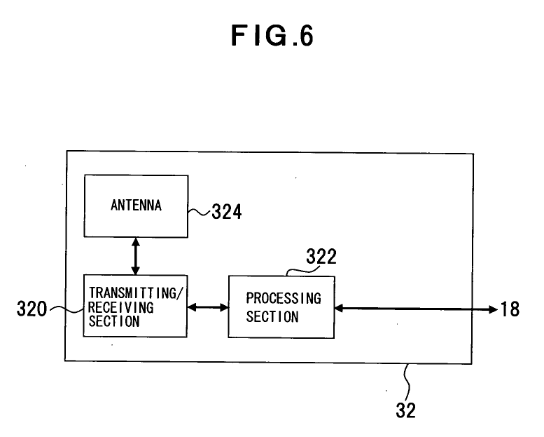

Next, the IC tag reader/writer 301, 302 is described referring to FIG. 4 and FIG. 5. FIG. 4 is a schematic side view showing a main body of the robot section 161, 162 having the IC tag reader/writer. FIG. 5 is a block diagram showing an example of the IC tag reader/writer 301, 302. The same reference numerals in FIG. 1 are used for the same constituents in FIG. 5 and FIG. 6.

As FIG. 4 shows, the robot section 161 has a main body section 281. The picker section 221 of the main body section 281 holds the cartridge 8. As described above, the cartridge 8 has the IC tag 100 as a recognition section 10, the IC tag reader/writer 301 for the IC tag 100 is installed in the main body section 281. Another robot section 162 is configured similarly to the robot section 161.

The IC tag reader/writer 301 has, as FIG. 5 shows, a transmitting/receiving section 310 and a processing section 312, and an antenna 314 is connected to the transmitting/receiving section 310. The transmitting/receiving section 310 transmits/receives wireless signals in a specified frequency through the antenna 314. The processing section 312 processes to detect the above described recognition information based on wireless information as the received signal, or modulate the recognition information into wireless information. The recognition information is written to the IC tag 100 through the IC tag reader/writer 301 by control by the library control section 18. Also, the wireless information received by the antenna 314 is detected by the transmitting/receiving section 310, and then delivered to the processing section 312 for detecting the recognition information. The detected recognition information is delivered to the library control section 18.

According to the above structure, the above described recognition information can be written or read therefrom using the IC tag reader/writer 301 installed in the vicinity of the IC tag 100 on the cartridge 8 held by the picker section 221 of the robot section 161. In other words, the above described recognition information can be written to the IC tag 100 of recognition section 10 on the cartridge 8 as a target at the robot section 161. In this case, read/write steps from/to the IC tag 100 are performed in the vicinity between the IC tag 100 and the IC tag reader/writer 301 on the main body section 281 of the robot section 161, whereby the accuracy of communicating information by wireless signals is improved, so that information is written/read with high reliability. Such processing and an advantage are the same also about robot section 162 and the IC tag reader/writer 302.

Next, an IC tag reader 32 is described referring to FIG. 6. FIG. 6 is a block diagram showing a structure of the IC tag reader 32. In FIG. 6, the same reference numerals are used for the same constituents in FIG. 1.

The IC tag reader 32 has a transmitting/receiving section 320 and the processing section 322, and an antenna 324 is connected to the transmitting/receiving section 320. The transmitting/receiving section 320 transmits/receives wireless information, and the processing section 322 processes the detection of the above described recognition information based on the wireless information as the received signal, and delivers the detected information to the library control section 18.

According to such structure, the IC tag reader 32 can read recognition information written in the IC tag 100. A cartridge 8 to be taken out from the library apparatus 6 can be contactlessly detected by means of the contact-less connection between the IC tag 100 and the IC tag reader 32.

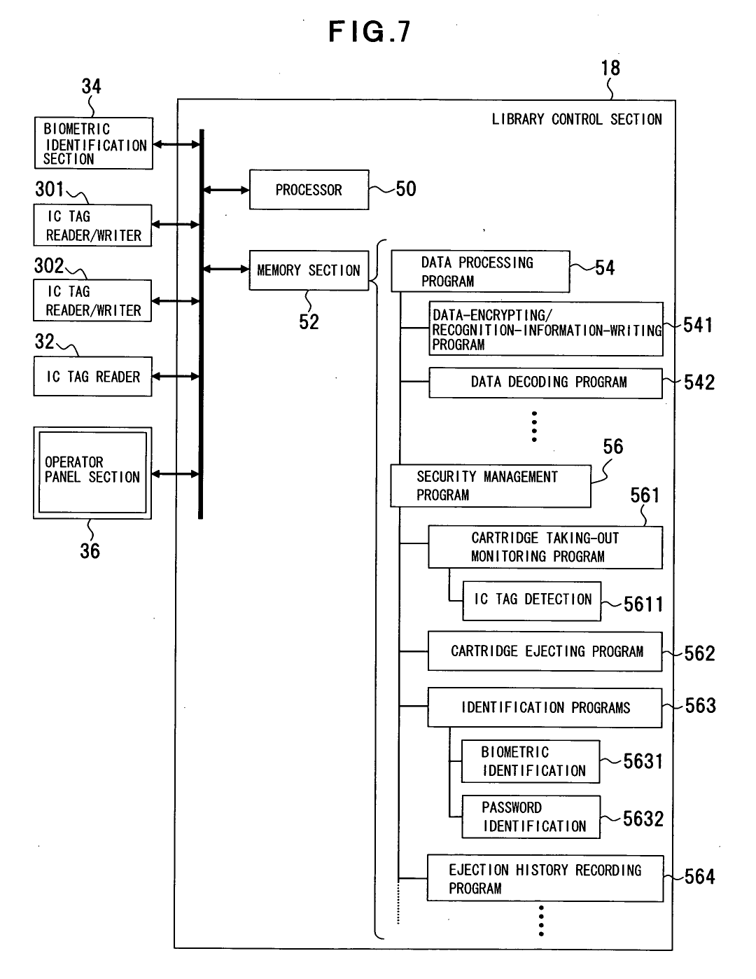

Next, the library control section 18 is described referring to FIG. 7. FIG. 7 is a block diagram showing an example of a library control section. In FIG. 7, the same reference numerals are used for the same constituents in FIG. 1.

The library control section 18 is comprised of a computer that includes a processor 50 for performing information processing and controlling and a memory section 52 for recording various data and program therein. In the memory section 52, a back-up software such as a data processing program 54 and a security management program 56 etc. are stored for performing such as control of the library control section 18, read/write of data from/to the cartridge 8 and their control, encryption/decoding of data, and write/read of the above described recognition information.

The data processing program 54 is used for storing various data in the cartridge 8. The data processing program 54 includes a data-encrypting/recognition-information-writing program 541, a data-decoding program 542, etc. The data-encrypting/ recognition-information-writing program 541 is used for encrypting non-encrypted data; the data-decoding program 542 is used for decoding the encrypted data.

The security management program 56 is used for the security management of the cartridge 8. The security management program 56 includes a cartridge taking-out monitoring program 561, a cartridge ejecting program 562, identification program 563, and an ejection history recording program 564 etc. The cartridge taking-out monitoring program 561 is used for preventing the cartridge 8 having non-encrypted data from being taken out. The cartridge taking-out monitoring program 561 includes a detection process 5611 for detecting the IC tag 100. The detection process 5611 includes an identification process for identifying if an operator is acceptable or not.

The cartridge ejecting program 562 is used for preventing the cartridge 8 having non-encrypted data therein from ejecting. The identification program 563 executes a identification process to identify if an operator is acceptable or not and includes a biometric identification 5631 and a password identification 5632 etc. The ejection history recording program 564 is used for recording and reading of ejection history information of the cartridge 8.

According to such structure, data recording/reading to/from the cartridge 8, and recognition information recording/reading to/from the IC tag 100, can be performed efficiently. Security management of the cartridge 8 and the recorded data can be performed, thereby preventing the recorded data from revising without authorization.

In this embodiment, the identification programs 563 are independently configured from other programs to have each program refer to the result of identification. The identification programs 563 can be configured as part of the cartridge taking-out monitoring program 561, or the cartridge ejecting program 562 etc. Also, the back-up software such as the data processing program 54 and the security management program 56 are independently configured as segmentalized programs. However, they can be configured as an integrated program as part of a data-processing program having the data security management feature.

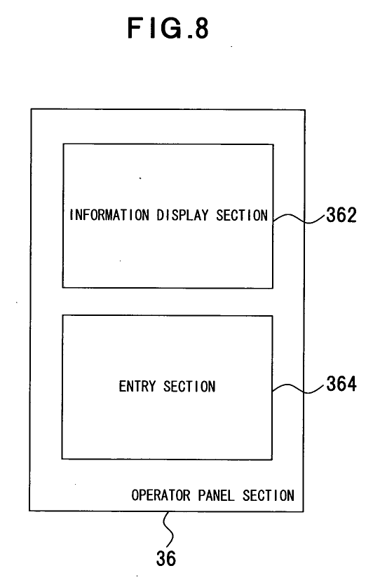

Next, the operator panel section 36 is described referring to FIG. 8. FIG. 8 is a block diagram showing a structure of the operator panel. In FIG. 8, the same reference numerals are used for the same constituents in FIG. 1.

The operator panel section 36 provides a user interface including an information display section 362 for displaying information of images and characters etc. and an entry section 364 for entering various information such as password, instructions for opening/closing the loading/ejecting port opening/closing section 38 for the cartridge 8. The information display section 362 is composed of, for example, Liquid Crystal Display. Also, the entry section 364 is composed of a keyboard and a touch sensor integrally with the information display section 362.

An example of a structure of the library apparatus 6 is described referring to FIG. 9. FIG. 9 is a perspective view showing the library apparatus 6 with which the cartridge storage section 14 is drawn forth from a cabinet. In FIG. 9, the same reference numerals are used for the same constituents in FIG. 1.

The library apparatus 6 has a cabinet 58 as a storage area for the cartridges 8, and a front door 60 is openably and closably attached to the cabinet 58. In the cabinet 58, the cartridge storage section 14, robot section 161, 162 etc. are provided. At the side of the cartridge storage section 14, the cartridge loading/ejecting port 44 is provided, the above described loading/ejecting port opening/closing section 38 is provided in the cartridge loading/ejecting port 44.

Further, a control board 62 having the library control section 18 is provided on the sidewall in the cabinet 58. In the vicinity of a front opening 64, the IC tag reader 32 and the biometric identification section 34 are provided. In this case, the IC tag reader 32 is positioned at the front of the cabinet 58. The alert lamp 42 is attached on the top 66 of the cabinet 58.

According to the above structure, information writing/reading from/to the cartridge 8 is performed, as a security management of the cartridge 8, it is recognized with the recognition section 10 on the cartridge 8 whether the recorded data is an encrypted data or non-encrypted data. Taking out the cartridge 8 from the cabinet 58 is recognized by the IC tag reader 32. The library control section 18 determines, by using biometric identification information of the biometric identification section 34, if the cartridge 8 can be ejected or not from the cartridge loading/ejecting port 44. As for these security management, upon anomaly occurring, the alert lamp 42 is activated to notify the anomaly.

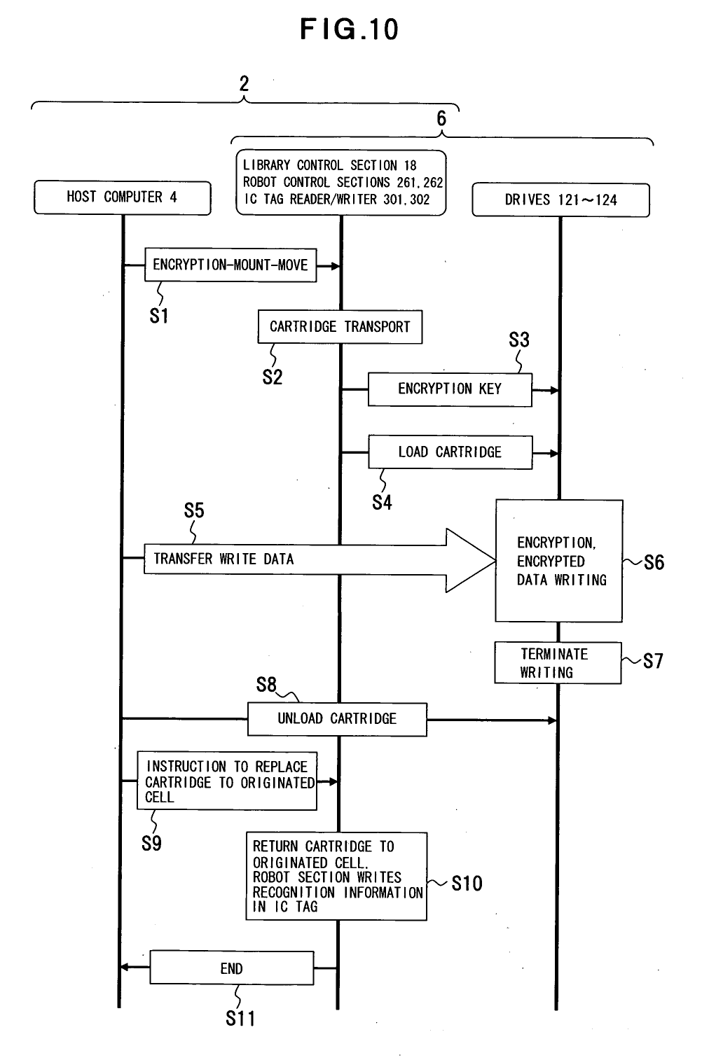

Next, referring to FIG. 10, described are encryption of the recorded data in the cartridge 8 and writing of recognition information into the IC tag 100, in information processing of the information processing apparatus 2. FIG. 10 is a block diagram showing operational sequence by the host computer 4 and the library apparatus 6. In FIG. 10, the same reference numerals are used for the same constituents in FIG. 1.

The process represented in the operational sequence is an example of a method of management for recording medium of the present invention, and an example of the above described data processing program 54 and the data-encrypting/recognition-information-writing program 541 etc.

The instruction of encryption-mount-move for specific cartridge 8 is given to the library control section 18 from the host computer 4 (Step S1), based on this instruction, the library control section 18 executes transport function of the cartridge 8 (Step S2), the library control section 18 issues an encryption key (Step S3), in this case, the encryption key is assigned to a specific drive for loading a cartridge 8, for example, the drive 121. This encryption key is, for example, generated using biometric information, identification information such as password etc. and stored in the database section 40. As an encryption key, other data other than identification information can be used. The cartridge 8 is loaded on the drive 121 to which the encryption key was assigned (Step S4).

After the above process, write data is transferred from the host computer 4 into the drive 121 (Step S5), writing of encrypted data is performed in the drive 121 (Step S6), after the encrypted data writing is completed (Step S7), the drive 121 is instructed to unload the cartridge 8 (Step S8).

After the instruction unloading the cartridge 8, the host computer 4 instructs the library control section 18 to replace the cartridge 8 having data writing completed to the originated cell 20 (Step S9).

Through the library control section 18, for example, the robot section 161 receives the cartridge 8 from the drive 121, and then returns the cartridge 8 to the originated cell 20, while the IC tag reader/writer 301 writes recognition information indicating that the recorded data is an encrypted data into the IC tag 100 on the cartridge 8 held by the picker section 221 (Step S10). In the case where the cartridge 8 is received from the drive 121 by the robot section 162 and the cartridge 8 is then returned to the originated cell 20, the IC tag reader/writer 302 writes recognition information indicating that the recorded data is an encrypted data into the IC tag 100 on the cartridge 8 held by the picker section 222.

In accordance with the above steps, data is written in the cartridge 8, after the recognition information is written in the IC tag 100 and the cartridge 8 is returned to the cell 20, the library control section 18 transmits the end of processing to the host computer 4 (Step S11).

According to the above steps, the recognition information indicating that the recorded data in the cartridge 8 is an encrypted data can be written into the IC tag 100 attached to the cartridge 8 in synchronization with the data writing to the cartridge 8 and its encryption.

In the process to read data from the cartridge 8, the instruction of decoding-mount-move for specific cartridge 8 is given to the library control section 18 from the host computer 4, based on this instruction, the library control section 18 executes the transport operation of the cartridge 8, the library control section 18 issue the above described encryption key, the encryption key is assigned to a specified drive, for example, the drive 121 for loading the cartridge 8 therein. The cartridge 8 is loaded in the drive 121 assigned the encryption key for executing the decoding process while reading the encrypted data from the cartridge 8. After the data reading is completed, an instruction for unloading the cartridge 8 from the drive 121 is instructed for returning the cartridge 8 to the specified cell 20 responding to the instruction for returning the cartridge 8 to the originated cell 20.

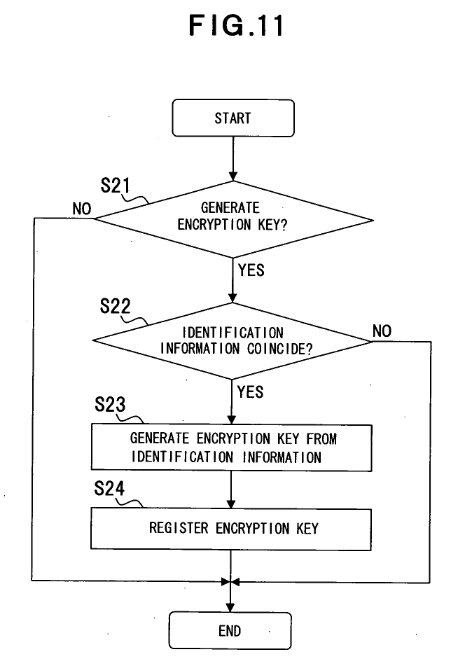

Next, generation of encryption key is described referring to FIG. 11. FIG. 11 is an example of a flow chart showing steps for encryption key generation.

The encryption key is generated responding to instructions from the operator panel section 36 and to encryption process of write data. Whether the generation of encryption key is executed or not is determined upon encryption key generation. (Step S21). The encryption key generation is terminated if it is not generated. If the encryption key is generated, (Yes at Step S21), it is determined whether an operator's identification information coincides with the registered identification information or not (Step S22), if they do not coincides, this process is terminated determining that it is an irregular process. If identification information is acceptable (YES at Step S22), an encryption key is generated using the identification information (Step S23), and the encryption key is registered in the database section 40 (Step S24), this process terminates.

Security of data can be improved by using such encryption key because encryption key can be used only when the identification information is coincided. An encrypted data processed by using such encryption key can be decoded only when identification information of a specific operator is identical.

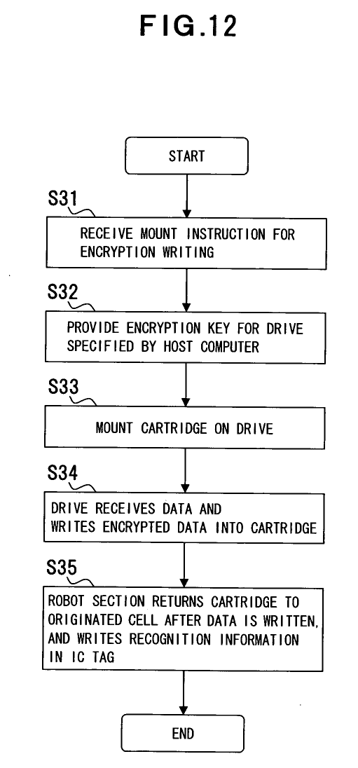

Next, process of data encryption and recognition information writing is described referring to FIG. 12. FIG. 12 is a flow chart showing steps for writing data by the drive and the IC tag reader/writer.

The process by this flow chart is an example of a method of management for recording medium of the present invention, and an example of the data processing program 54 or the data-encrypting/recognition-information-writing program 541.

The library control section 18 receives a mount instruction for encryption writing from the host computer 4 (Step S31), corresponding to the mount instruction, the host computer 4 provides an encryption key for the specified drive, for example drive 121 (Step S32). In this case, the robot section 161 is selected; the cartridge 8 is then mounted on the drive 121 by its transport movement (Step S33). The drive 121 receives a data transferred from the host computer 4 by the back-up software for writing the encrypted data into the cartridge 8 (Step S34). The cartridge 8 is returned to the originated cell 20 by the robot section 161 after the data has been written, during this period, the IC tag reader/writer 301 of the robot section 161 writes the recognition information that the recorded data is an encrypted data into the IC tag 100 (Step S35).

In the above step, the encryption key is encryption information to be used for encrypting the recorded data in the cartridge 8. This encryption information is generated based on identification information such as biometric information entered by the biometric identification section 34. (Ref. FIG. 11).

According to this process, after encryption process and data-writing process based on the instruction of data writing from the host computer 4, the recognition information indicating that the recorded data is an encrypted data can be recorded in the IC tag 100.

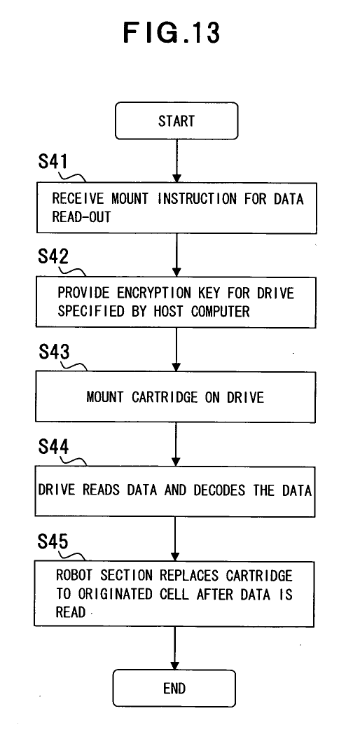

Next, data-decoding process is described referring to FIG. 13. FIG. 13 is a flow chart which shows data read-out and decoding by the drive.

This flow chart shows an example of data-decoding program 542 in FIG. 7.

The library control section 18 receives a mount instruction for data read-out (Step S41), corresponding to this mount instruction, the drive specified by the host computer 4, for example, drive 121 receives an encryption key (Step S42). The cartridge 8 is mounted on the drive 121 by the transport movement of the selected robot section 161 (Step S43). The drive 121 executes the decoding of data by using the encryption key provided after an encrypted data is read from the cartridge 8 (Step S44). The cartridge 8 is replaced to the originated cell 20 by the robot section 161 after reading of the data is terminated (Step S45).

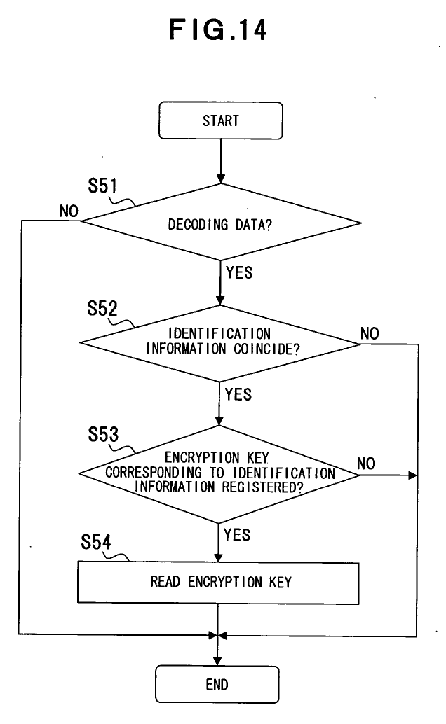

Next, reading process of the encryption key is described referring to FIG. 14. FIG. 14 is a flow chart showing steps for reading the encryption key.

This process is executed corresponding to encrypted data read-out and its decoding process. In this process, it is determined whether it is decoding of the recorded data or not (Step S51), the process terminates if decoding is not performed, if decoding process is performed, it is determined whether an operator's identification information coincides the preliminary registered identification information (Step S52). If they do not coincide, the process terminates considering that it is an irregular process. If the identification information is acceptable, (YES at Step S52), it is determined whether an encryption key corresponding to the identification information is registered or not (Step S53). This process terminates if the encryption key is not registered, (NO at Step 53). If the encryption key is registered (YES at S53), the process terminates after the encryption key is read (Step S54). Decoding process of the encrypted data is executed by using the read encryption key (Refer to FIG. 3).

Security of the encrypted data can be improved by using such encryption key because the encrypted data cannot be decoded unless the operator's identification information coincides

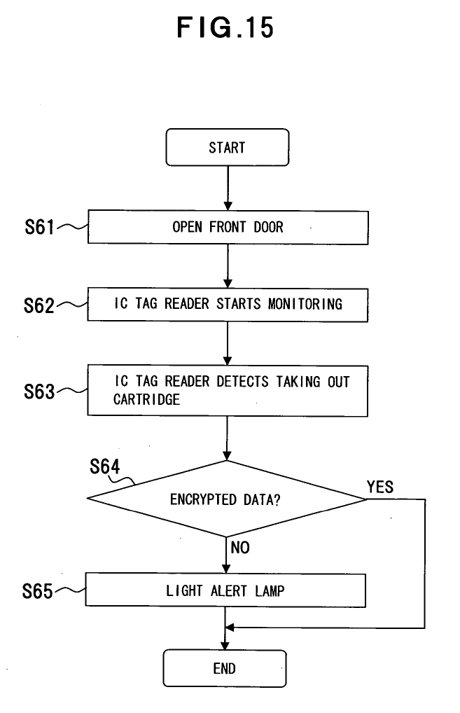

Next, monitoring of taking out the cartridge 8 is described referring to FIG. 15. FIG. 15 is a flow chart showing process of monitoring the cartridge 8 to be taken out.

The process by this flow chart shows an example of a management method for recording medium of the present invention, and an example of the security management programs 56, the cartridge taking-out monitoring program 561 and the identification programs 563 (Refer to FIG. 7).

When the front door 60 of,the library apparatus 6 is in the state of open (Step S61), the cartridge 8 can be taken out. Wireless communication is performed between the IC tag reader 32 installed at a front lower part of the library apparatus 6 and the IC tag 100 of the cartridge 8 to be taken out, and monitoring of the cartridge 8 is started (Step S62). That is, taking out of the cartridge 8 is detected by the IC tag reader 32.

When the cartridge 8 is taken out from the cell 20 in the library apparatus 6, the cartridge 8 is detected by the IC tag reader 32 (Step S63), the library control section 18 receives recognition information read from the IC tag 100 attached to the cartridge 8. The library control section 18 determines whether the recorded data in the cartridge 8 is an encrypted data or non-encrypted data based on the recognition information. This process terminates if the recorded data in the cartridge 8 is an encrypted data (YES at Step 64). If the recorded data is a non-encrypted data (NO at Step 64), the alert lamp 42 is lit (Step S65) so that taking out of the cartridge 8 whose recording data is a non-encrypted data is notified and alerted.

According to such structure, security of the cartridge 8 and the recorded data therein can be protected by warning taking out the cartridge 8 recording a non-encrypted data based on the detection of the recognition information read from the IC tag 100 attached to the cartridge 8.

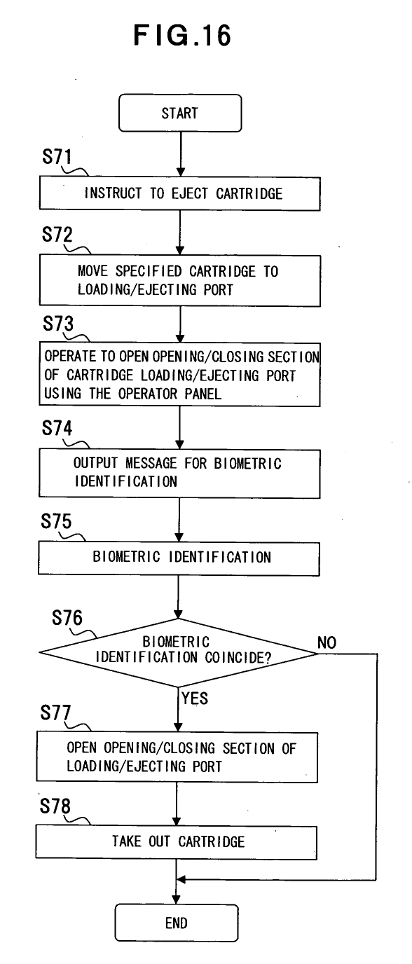

Next, ejection process of the cartridge and identification process is described referring to FIG. 16. FIG. 16 is a flow chart showing the cartridge ejection process and biometric identification process. This process by the flow chart is an example of a management method for a recording medium of the present invention, and an example of the security management programs 56, the cartridge ejecting program 562 and the identification program 563 (Refer to FIG. 7).

According to the back-up software as described above, responding to ejecting instruction of the cartridge 8 (Step 71), the robot section 161 or 162 transports the specified cartridge 8 to the cartridge loading/ejecting port 44 (Step S72). In order to take out the transported cartridge 8, an operator enters an instruction in the operator panel to open the loading/ejecting port opening/closing section 38 of the cartridge loading/ejecting port 44 (Step 73). After this instruction is received, message showing performing biometric identification as identification process is outputted to the operator panel section 36 from the library control section 18 so as to inform the operator (Step S74). The operator enters biometric information such as venous information etc. The biometric identification is performed using the biometric information entered by the operator (Step S75). In this step, the biometric information preliminary registered by the operator and the biometric information entered by the operator are verified (Step S76). If they coincide after the verification (YES at Step S76), the identification is approved, and the opening/closing section 38 at the cartridge loading/ejecting port 44 is opened (Step S77). By this operation, the cartridge 8 can be taken out and the operator can take out the cartridge 8 from the cartridge loading/ejecting port 44(Step S78).

According to the above structure, the opening/closing section 38 of the cartridge loading/ejecting port 44 is controlled by the operator's biometric identification. The ejection of the cartridge 8 is prohibited if biometric information does not coincide, thereby improving the security of the cartridge 8 and recorded data therein by protecting from any unauthorized person taking out the cartridge 8.

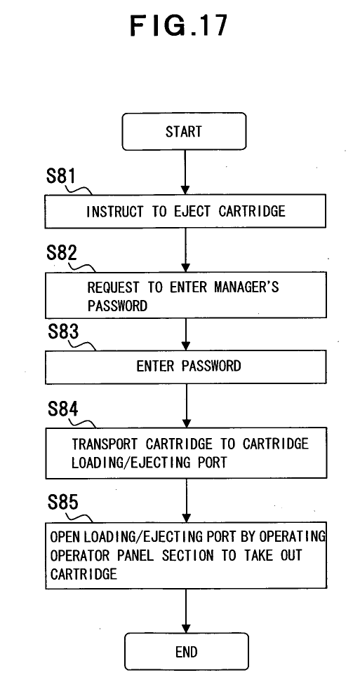

Next, the cartridge ejection process and the password identification process are described referring to FIG. 17. FIG. 17 is a flow chart showing process for the cartridge ejecting process including the password identification step.

The process by this flow chart an example of a management method of a recording medium of the present invention, and an example of the security management programs 56, the cartridge ejecting program 562 and the identification program 563 (Refer to FIG. 7).

According to the back-up software as described above, responding to ejecting instruction of the cartridge 8 (Step 81), a message for requesting a password entry is indicated on the operator panel section 36 to instruct the operator. (Step S82). The operator enters a password in the operator panel section 36 (Step S83). In this step, a password preliminary registered by the operator and the entered password are verified, if they coincide after the verification, the identification is approved so that the cartridge 8 can be taken out from the cartridge loading/ejecting port 44. In this step, the robot section 161 or 162 transports the cartridge 8 to the cartridge loading/ejecting port 44 (Step S84). The operator opens the opening/closing section 38 of the cartridge loading/ejecting port 44 by operating the operator panel section 36, whereby the operator can take out the cartridge 8 from the cartridge loading/ejecting port 44 (Step S85).

According to the above structure, the opening/closing section 38 of the cartridge loading/ejecting port 44 is controlled by the password identification of the operator. If the password does not coincide, the ejection of the cartridge 8 is prohibited. Security of the cartridge 8 and the recorded data therein are thus protected from taking out by an unauthorized person.

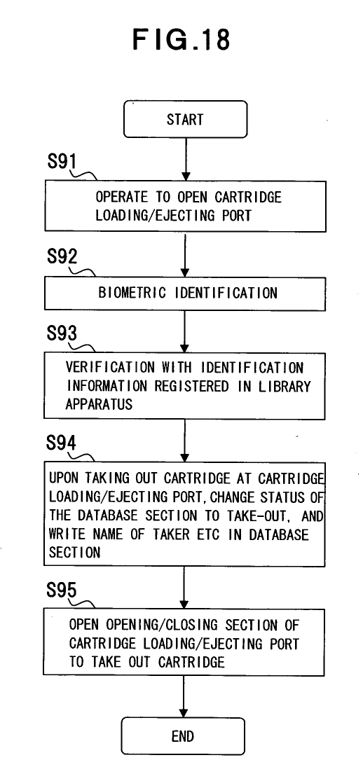

Next, ejection history recording for the ejected cartridges is described referring to FIG. 18. FIG. 18 is a flow chart showing cartridge ejection process including ejection history recording process.

The process by this flow chart is an example of a management method of a recording medium of the present invention, and an example of the security management programs 56, and the ejection history recording program 564 (Refer to FIG. 7).

It is operated to open the above described cartridge loading/ejecting port 44. (Step S91), the biometric identification is performed during this period (Step S92). The entered biometric information is verified with identification information registered during the biometric identification (Step S93). Based on a result of the verification, the cartridge 8 can be taken out. In the case of taking out the cartridge 8 at the cartridge loading/ejecting port 44, the status of the database section 40 is changed to the status of take-out with respect to the cartridge 8 to be taken out; and history information such as the name of the taker, taking-out date and time, etc. is written to the database section 40 (Step S94). In other words, the history information such as record of the taken out cartridge 8, the name of the taker, date and time etc. are recorded in the database section 40.

On a condition that such history information is recorded, the opening/closing section 38 of the cartridge loading/ejecting port 44 is opened so that the cartridge 8 is enabled to take out (Step S95).

According to this structure, protected is taking out the cartridge 8 by an unauthorized person, and enhanced is the security of the cartridge 8 and the recorded data therein; because, upon taking out the cartridge 8, it is possible to record the history information such as record of the cartridge 8 to be taken out, the name of the taker and taking-out date and time and it is possible to take out the cartridge 8 on a condition recording the history information.

### Second Embodiment

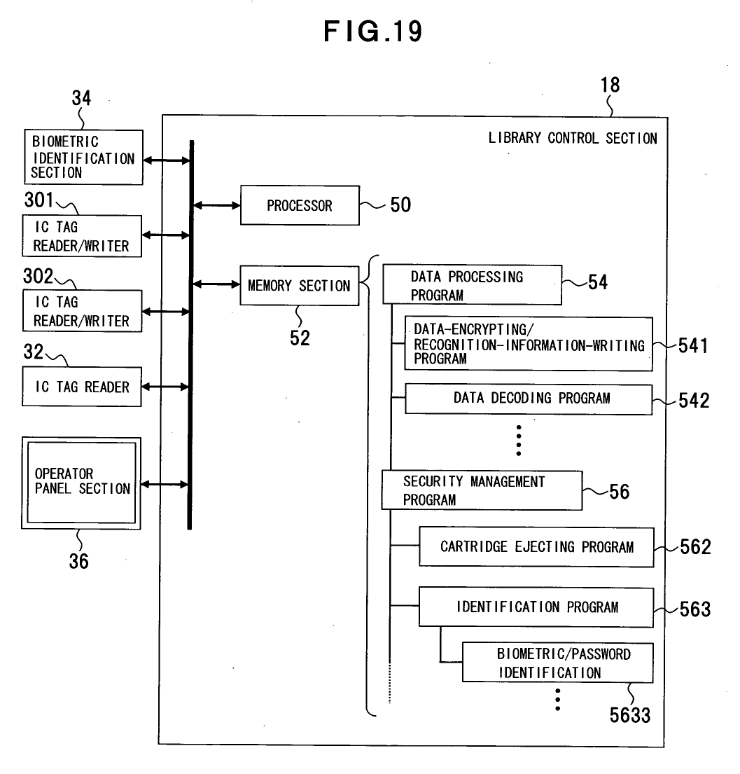

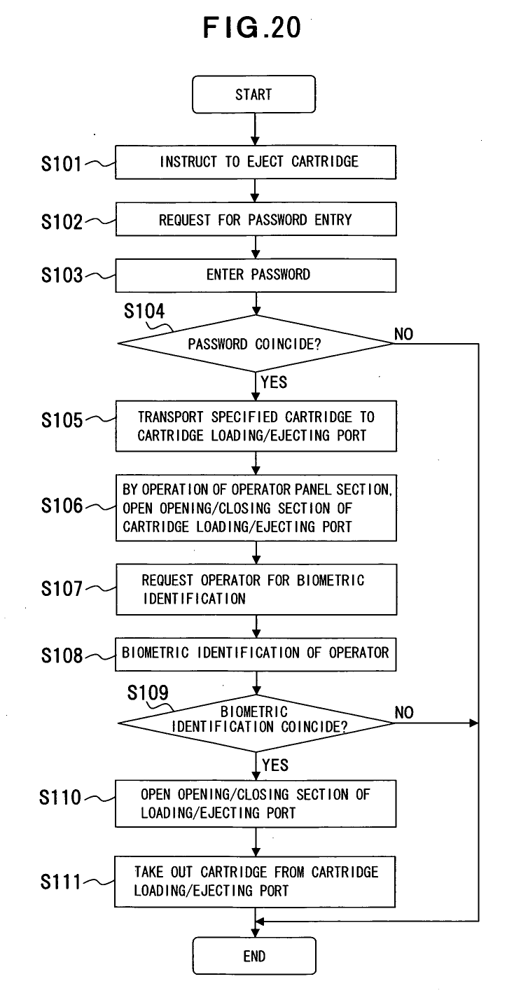

Referring to FIGS. 19 and 20, described are a method of managing recording medium, recording medium, library apparatus and an information processing apparatus according to a second embodiment of the present invention. FIG. 19 is a block diagram showing the structure of a library control section of a second embodiment of the present invention. FIG. 20 is a flow chart showing cartridge ejection process including a password identification process and biometric identification process. In FIG. 19, the same reference numerals are used for the same constituents in FIG. 7.

In this embodiment, it is structured to include a biometric/password identification 5633 which uses a biometric identification and a password identification together with the cartridge ejecting program 562 in security management program 56. The security management program 56 is recorded in the memory section 52 of the library control section 18.

According to this structure, as FIG. 20 shows, responding to an instruction for ejecting the cartridge 8 using the back-up software (Step S101), the back-up software request for a password entry (Step S102). More specifically, the password entry is requested by showing an image requesting for a password entry on the operator panel section 36. In response to the instruction for its entry, the operator enters a password using a user interface such as a keyboard etc. (Step S103). The password entered is compared with a password preliminary registered to determine whether they coincide or not (Step S104). If the password entered does not coincide with the password preliminary registered (NO at Step 104), the operator is requested to enter the password again. In the case where password entry and mismatch over several times is confirmed, the process is terminated. If the password entered coincides (YES at Step 104), the robot section 161 or the robot section 162 transports the specified cartridge 8 to the cartridge loading/ejecting port 44 (Step S105).

By entering to the operator panel section 36, the operator operates the operator panel section 36 to open the opening/closing section 38 of the cartridge loading/ejecting port 44 to take out the cartridge 8 transported (Step S106). When this instruction is received, a message for requesting the biometric identification is indicated on the operator panel section 36 from the library control section 18 to notify the operator (Step S107). The operator enters biometric information such as venous information etc. to the biometric identification section 34 to perform the biometric identification based on the biometric information entered (Step S108). The biometric information entered and the biometric information preliminary registered by the operator are verified (Step S109). If they do not coincide after the verification (NO at Step S109) this access is terminated. If they coincide after the comparison (YES at Step S109) identification is determined as a success to open the opening/closing section 38 of the cartridge loading/ejecting port 44 (Step S110). After this step, the cartridge 8 is enabled for taking out to have the operator take out the cartridge 8 from the cartridge loading/ejecting port 44 (Step S111).

According to the above structure, the opening/closing section 38 of the cartridge loading/ejecting port 44 is controlled by the operator's password identification in combination with biometric identification, whereby the ejection of the cartridge 8 is prohibited if each of the password data and the biometric information do not coincide, thereby improving the security of the cartridge 8 and the recoded data therein by protecting from an unauthorized person taking out the cartridge 8.

### Other Embodiments

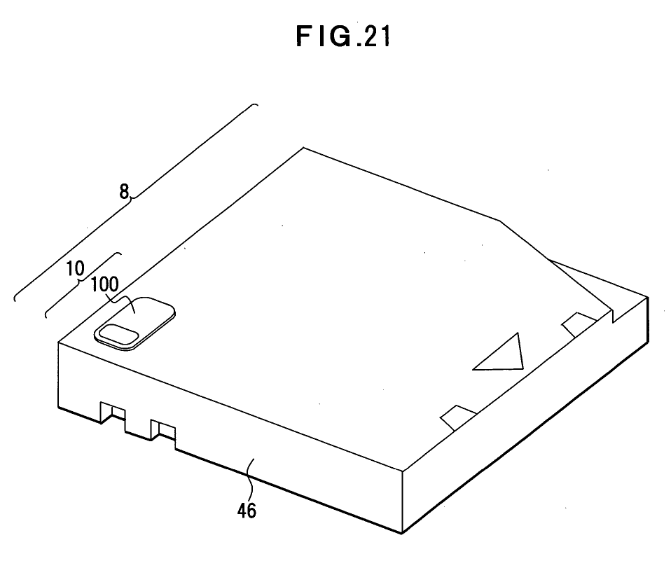

(1) The IC tag 100 as a recognition section 10 attached to the cartridge 8 can be stuck on the surface area of the case 46 of the cartridge 8 as shown in FIG. 21.

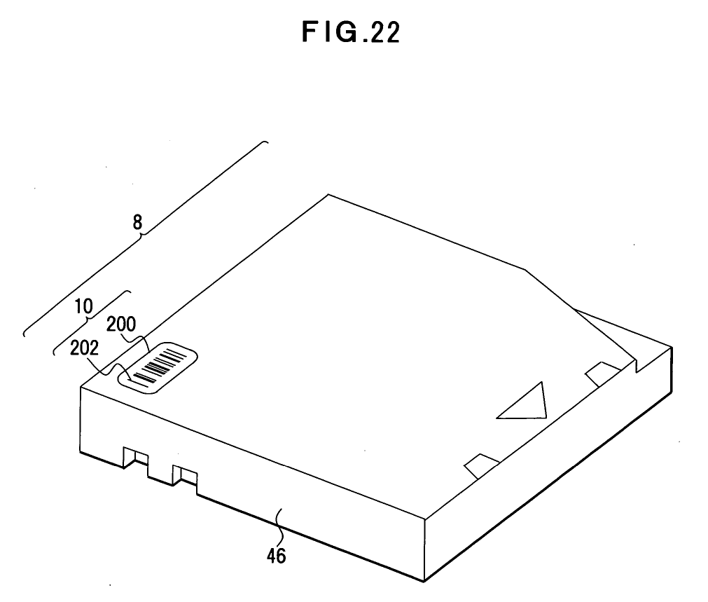

(2) As shown in FIG. 22, instead of the IC tag 100, a bar code display 200 can be used for the recognition section 10 attached to the cartridge 8 and be stuck on the surface of the case 46 of the cartridge 8. In this case, it's only necessary to display by a bar code 202 whether the recorded data in the cartridge 8 is an encrypted data or a non encrypted data.

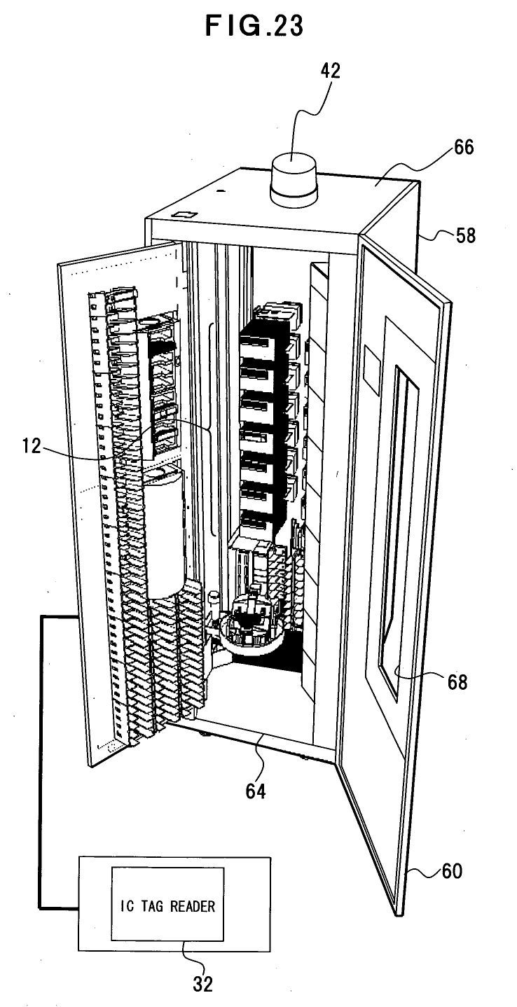

(3) The structure of the library apparatus 6 can be structured as shown in FIG. 23 such as the front door 60 movably attached to open/close on the cabinet 58 has a loading/ejecting window 68 for the cartridges 8 whereby the cartridges 8 can be installed or detached against each of the drives 121-127 of the group of drives 12 through the loading/ejecting window 68. In this case, the IC tag reader 32 is provided in the vicinity of the front opening 64 of the cabinet 58 for detecting the cartridge 8 to be taken out by the IC tag 100. Similarly to the above embodiments, the alert lamp 42 provided on the top 66 of the cabinet 58 is lit in the case of anomaly. In FIG. 23, the same reference numerals are used for the constituents in FIGS. 1 and 9.

(4) The robot sections 161, 162 for transporting the cartridge 8, described in the above embodiments, includes what is called accessor.

(5) According to the above embodiments, encryption information is generated based on the identification information; however it can be structured that the encryption information can be provided from the host computer 4. Also, as an example of the structure for generating the encryption information based on the identification information, it is exemplified to generate the encryption information from biometric information; however two or more biometric information can be used in combination for generating the encryption information.

The present invention relates to the management of security for recording medium such as magnetic tape stored in the cartridge, more specifically, the present invention is useful for protecting from taking out recording medium or writing into the recorded data in the medium, by an unauthorized person.

As described above, most preferred embodiments of the present invention are described; however the present invention is not limited to the above embodiments.

Needless to say, any modifications or changes that can be implemented by those skilled in the art within the scope of the claims defined and the description disclosed in the present specification are included within the scope of the present invention.

What is claimed is:

1. A method of managing a recording medium recording an encrypted data or a non-encrypted data therein, comprising the steps of:
generating recognition information recognizing whether a data recorded in the recording medium is an encrypted data or a non-encrypted data; and
writing said recognition information into a recognition section attached to said recording medium.

2. A library apparatus storing a recording medium, the recording medium comprising:
a recognition section in which recognition information recognizing whether a recorded data is an encrypted data or a non-encrypted data is written.

3. The library apparatus of claim 2, further comprising:
a recognition information writing section writing said recognition information into said recognition section.

4. The library apparatus of claim 2, further comprising:
a recognition information reading section reading said recognition information from said recognition section.

5. The library apparatus of claim 2, further comprising:
a detection section detecting removal of said recording medium from a storage area; and
a notification section generating notification output indicating the removal of said recording medium from said storage area based on output detected by said detection section.

6. The library apparatus of claim 2, further comprising:
an entry section entering identification information; and
a processing section deciding whether said identification information coincides with identification information preliminary registered, and prohibiting ejection of said recording medium or data processing in case that said identification information does not coincide with the identification information preliminary registered.

7. The library apparatus of claim 2, further comprising:
an entry section entering identification information; and
a processing section encrypting said recorded data by using encryption information generated based on said identification information, and recording the encrypted data in said recording medium.

8. The library apparatus of claim 2, further comprising:
an encryption information generation section generating encryption information based on identification information.

9. The library apparatus of claim 6, wherein said identification information is biometric information.

10. An information processing apparatus having a library apparatus storing a recording medium, the recording medium comprising:
a recognition section in which recognition information recognizing whether a recorded data is an encrypted data or a non-encrypted data is written.

11. The information processing apparatus of claim 10, further comprising:
a recognition information writing section writing said recognition information into said recognition section.

12. The information processing apparatus of claim 10, further comprising:
a recognition information reading section reading said recognition information from said recognition section.

13. The information processing apparatus of claim 10, further comprising:
a detection section detecting removal of said recording medium from a storage area; and
an notification section generating notification output indicating the removal of said recording medium from said storage area based on output detected by said detection section.

14. The information processing apparatus of claim 10, further comprising:
an entry section entering identification information; and
a processing section deciding whether said identification information coincides with identification information preliminary registered, and prohibiting ejection of said recording medium or data processing in case that said identification information does not coincide with the identification information preliminary registered.

15. The information processing apparatus of claim 10, further comprising:
an entry section entering identification information; and
a processing section encrypting said recorded data by using encryption information generated based on said identification information, and recording the encrypted data in said recording medium.

16. The information processing apparatus of claim 10, further comprising:
an encryption information generation section generating encryption information based on identification information.

17. The information processing apparatus of claim 14, wherein said identification information is biometric information.
